(19) United States
(12) Patent Application Publication
(10) Pub. No.: US 2021/0087067 A1
(43) Pub. Date: Mar. 25, 2021

(54) METHOD FOR PRODUCING SILICA SOL

(71) Applicant: FUJIMI INCORPORATED, Kiyosu-shi (JP)

(72) Inventors: Keiji ASHITAKA, Kiyosu-shi (JP); Yusuke KAWASAKI, Kiyosu-shi (JP); Masaaki ITO, Kiyosu-shi (JP); Jun SHINODA, Kiyosu-shi (JP); Shogo TSUBOTA, Kiyosu-shi (JP)

(73) Assignee: FUJIMI INCORPORATED, Kiyosu-shi (JP)

(21) Appl. No.: 17/022,876

(22) Filed: Sep. 16, 2020

(30) Foreign Application Priority Data
Sep. 20, 2019 (JP) 2019-171827

(51) Int. Cl. C01B 33/145

(52) U.S. Cl. CPC C01B 33/145; C01P 2004/03

(57) ABSTRACT

There is provided a method for producing a silica sol including: a first step of adding an organic acid to at least one of liquid (A) containing an alkaline catalyst, water, and a first organic solvent and liquid (C) containing water; and a second step of mixing the liquid (A) with liquid (B) containing an alkoxysilane or its condensate and a second organic solvent, and the liquid (C) to make a reaction liquid after the first step.

### CROSS-REFERENCE TO RELATED APPLICATION

The entire disclosure of Japanese Patent Application No. 2019-171827 filed on Sep. 20, 2019, is incorporated herein by reference in its entirety.

### BACKGROUND

### 1. Technical Field

The present invention relates to a method for producing a silica sol.

### 2. Description of Related Arts

Conventionally, chemical mechanical polishing (CMP) using a polishing composition has been performed on the surface of materials such as metals, semimetals, nonmetals, and their oxides. It is known that this polishing composition generally has a composition in which an aqueous solution having a chemical polishing action and particles (abrasive grains) having a mechanical polishing action are mixed and dispersed, and a silica sol is used as the abrasive grains.

Silica sol is known to change the performance during polishing depending on the particle size and shape of the silica particles. For example, it is known that irregular-shaped silica particles in which two or more silica particles are associated with each other have a higher polishing speed of an object to be polished than spherical silica particles which are not associated with other silica particles (see Proceedings of Spring Meeting of the Japan Society for Precision Engineering, (2007), pp. 1147-1148).

On the other hand, a method for producing a silica sol including mixing liquid (A) containing an alkaline catalyst, liquid (B) containing an alkoxysilane or its condensate, and liquid (C) containing water to make a reaction liquid is disclosed in WO 2017/022552 (corresponding to US 2019/010059 A1, CN 107848811 A, and TW 201716328 A). According to this method, regardless of the size of silica particles, a silica sol having a uniform particle size of silica particles can be consistently produced.

### SUMMARY

However, the circularity of silica particles included in a silica sol obtained by the method of WO 2017/022552 (corresponding to US 2019/010059 A1, CN 107848811 A, and TW 201716328 A) is high, and thus there is still room for improvement in terms of obtaining irregular-shaped silica particles having a low circularity which improve polishing performance.

The present invention has been made in view of the above circumstances, and an object of the present invention is to provide a method for producing a silica sol capable of providing consistent production of the silica sol having a low average circularity of silica particles.

The present inventors have carried out a diligent study to solve the problems described above. As a result, they have found out that the above-described problems are solved by a method for producing a silica sol including: a first step of adding an organic acid to at least one of liquid (A) containing an alkaline catalyst, water, and a first organic solvent and liquid (C) containing water; and a second step of mixing the liquid (A) with liquid (B) containing an alkoxysilane or its condensate and a second organic solvent, and the liquid (C) to make a reaction liquid after the first step, and completed the present invention.

According to the present invention, there is provided a method for producing a silica sol capable of providing consistent production of the silica sol having a lower average circularity of silica particles.

### BRIEF DESCRIPTION OF THE DRAWINGS

FIGS. 1A and 1B are view showing irregular-shaped silica particles; and

FIG. 2 is a photograph of a silica sol produced in Example 1, which is observed with a scanning electron microscope.

### DETAILED DESCRIPTION

Hereinafter, embodiments of the present invention are described, but the present invention is not limited only to the following embodiments. Note that, unless otherwise indicated, operations and measurements of physical properties are carried out under conditions of room temperature (20 to 25° C.) and relative humidity of to 50% RH. Further, in the present specification, the expression “X to Y” showing a range represents “X or more and Y or less”.

A method for producing a silica sol according to a mode of the present invention includes: a first step of a first step of adding an organic acid to at least one of liquid (A) containing an alkaline catalyst, water, and a first organic solvent (also referred to as “liquid (A)” in the present specification) and liquid (C) containing water (also referred to as “liquid (C)” in the present specification); and a second step of mixing the liquid (A) with liquid (B) containing an alkoxysilane or its condensate and a second organic solvent (also referred to as “liquid (B)” in the present specification), and the liquid (C) to make a reaction liquid after the first step. In the first step, the organic acid is added to at least one of liquid (A) and liquid (C). Thus, in the reaction liquid, an alkoxysilane or its condensate is hydrolyzed and polycondensed in the presence of the organic acid to produce a silica sol in the second step. According to the configuration, a method for producing a silica sol of the present invention can provide consistent production of the silica sol having a lower average circularity of silica particles.

Although it is not necessarily clear why the above-described effects are obtained by the production method of the present invention, a presumed mechanism is as follows. An organic acid is added to at least one of liquid (A) and liquid (C) in a first step, and liquid (B) is mixed with liquid (A) and liquid (C) in the presence of an organic acid in a second step. That is, it is considered that, when an alkoxysilane or its condensate is in contact with an alkaline catalyst of liquid (A), an organic acid is present, this reduces contact locally between an alkoxysilane or its condensate and a large amount of an alkaline catalyst, and rapid grain growth is suppressed, whereby silica particles having a lower average circularity (preferably 0.60 or less) are formed. However, the above-described mechanism is a mere presumption, and, needless to say, does not limit the technical scope of the present invention.

In a preferred embodiment of the present invention, the liquid (C) is liquid (C1) having a pH of 5.0 or more and less than 8.0 and containing water or liquid (C2) containing water and being free of an alkaline catalyst. Hence, in order not to elevate concentration of an alkaline catalyst locally, a silica sol is produced, preferably, using liquid (C1) having a pH of 5.0 or more and less than 8.0 and containing the greatest amount, in molar ratio, of “water for hydrolysis” among the three constituents, which are rate determining factors of the reaction. Alternatively, in order not to elevate concentration of an alkaline catalyst locally, a silica sol is produced, preferably, using liquid (C2) containing water and being free of an alkaline catalyst on the addition side. Thus, in a multi-liquid reaction using three or more liquids, it is possible to consistently produce a silica sol having a uniform particle size of silica particles while forming silica particles having a lower circularity.

In the present invention, from the viewpoint of purity (high purification) of the obtained silica sol, it is especially preferred that the silica sol is produced by a sol-gel process. The sol-gel process refers to a process of using a solution of an organometallic compound as a starting material, hydrolyzing and polycondensing a compound in a solution to make the solution into a sol in which fine particles of an oxide or a hydroxide of a metal are dissolved, and further carrying out a reaction to obtain an amorphous gel formed by gelation. In the present invention, a silica sol can be obtained by hydrolyzing an alkoxysilane or its condensate in an organic solvent containing water.

However, a production method of the present invention is not only applied to production of a silica sol, but also can be applied to a synthesis of a metal oxide except for a synthesis of a silica sol by a sol-gel process.

<<Method for Producing Silica Sol>>

A method for producing a silica sol of the present invention includes: a first step of adding an organic acid to at least one of liquid (A) containing an alkaline catalyst, water, and a first organic solvent and liquid (C) containing water; and a second step of mixing the liquid (A) with liquid (B) containing an alkoxysilane or its condensate and a second organic solvent, and the liquid (C) to make a reaction liquid after the first step. In the resultant reaction liquid, an alkoxysilane or its condensate is hydrolyzed and polycondensed to produce a silica sol. Constituent features of the method for producing a silica sol of the present invention are described below.

In the present invention, the liquid (C) is, preferably, liquid (C1) having a pH of 5.0 or more and less than 8.0 and containing water or liquid (C2) containing water and being free of an alkaline catalyst. Hereinafter, a mode using liquid (C) containing water is referred to as “first embodiment”, a mode using liquid (C1) having a pH of 5.0 or more and less than 8.0 and containing water as liquid (C) is referred to as “second embodiment”, and a mode using liquid (C2) containing water as liquid (C) and being free of an alkaline catalyst is referred to as “third embodiment”.

[Liquid (A) Containing Alkaline Catalyst, Water, and First Organic Solvent]

Liquid (A) is common in the first to third embodiments of the present invention, and the following description is also common to them.

Liquid (A) containing an alkaline catalyst, water, and a first organic solvent of the present invention can be prepared by mixing an alkaline catalyst, water, and a first organic solvent. In addition to the alkaline catalyst, water, and the organic solvent, and an organic acid to be added, if necessary, liquid (A) can contain other constituents so long as they do not impair the effect of the present invention.

As an alkaline catalyst contained in liquid (A), conventionally known alkaline catalysts can be used. From the viewpoint that contamination of a metallic impurity or the like can be reduced as much as possible, the alkaline catalyst is preferably at least one of ammonia, tetramethylammonium hydroxide, and other ammonium salts, or the like. Among the above-described alkaline catalysts, from the viewpoint of an excellent catalytic action, ammonia is more preferred. Since ammonia is highly volatile, it can be easily removed from the silica sol. Note that, the alkaline catalyst may be used solely, or two or more of the alkaline catalysts may be used in combination.

As water contained in liquid (A), from the viewpoint of reducing contamination of a metallic impurity or the like, pure water or ultrapure water is preferably used.

As a first organic solvent contained in liquid (A), a hydrophilic organic solvent is preferably used. Specific examples of the first organic solvent include alcohols such as methanol, ethanol, n-propanol, isopropanol, ethylene glycol, propylene glycol, 1,4-butanediol; and ketones such as acetone and methyl ethyl ketone, or the like.

Especially in the present invention, as the first organic solvent, alcohols are preferred. There is an effect such that, by using alcohols, when water substitution (described below) of the silica sol is carried out, alcohols can be easily substituted with water by heat distillation. Further, from the viewpoint of recovery and reuse of organic solvents, it is preferable to use alcohols of the same types as an alcohol produced by hydrolysis of an alkoxysilane.

Among the alcohols, at least one of methanol, ethanol, isopropanol, or the like is more preferred. When tetramethoxysilane is used as an alkoxysilane, a first organic solvent is preferably methanol.

The first organic solvent may be used solely, or two or more of the first organic solvents may be used in combination.

Contents of an alkaline catalyst, water, and a first organic solvent in liquid (A) are not specifically limited, and an alkaline catalyst, water, and a first organic solvent used can be changed according to a desired particle size, and contents of an alkaline catalyst, water, or a first organic solvent can be suitably adjusted according to each kind of the alkaline catalyst, water, or the first organic solvent used. In the production method of the present invention, by regulating a content of an alkaline catalyst in liquid (A), a particle size of a silica particle can be regulated.

For example, when ammonia is used as an alkaline catalyst, a lower limit of a content of ammonia is, from the viewpoint of an effect as a hydrolysis catalyst or growth of a silica particle, preferably 0.1% by mass or more, and more preferably 0.3% by mass or more with respect to the whole amount of liquid (A) (100% by mass). Further, an upper limit of a content of ammonia is not specifically limited, and from the viewpoint of productivity and cost, the upper limit is preferably 50% by mass or less, more preferably 40% by mass or less, and still more preferably 20% by mass or less.

A lower limit of a content of water is adjusted according to an amount of an alkoxysilane or its condensate used for reaction, and the lower limit is, from the viewpoint of hydrolysis of an alkoxysilane, preferably 5% by mass or more, and more preferably 10% by mass or more with respect to the whole amount of liquid (A) (100% by mass). Further, an upper limit of a content of water is, from the viewpoint of compatibility with liquid (B), preferably 50% by mass or less, and more preferably 40% by mass or less with respect to the whole amount of liquid (A) (100% by mass). A lower limit of a content of a first organic solvent is, from the viewpoint of compatibility with liquid (B), preferably 10% by mass or more, and more preferably 20% by mass or more with respect to the whole amount of liquid (A) (100% by mass). Further, an upper limit of a content of a first organic solvent is, from the viewpoint of dispersibility, preferably 94% by mass or less, and more preferably 90% by mass or less with respect to the whole amount of liquid (A) (100% by mass).

When methanol is used as a first organic solvent, a lower limit of a content of methanol is, from the viewpoint of compatibility with liquid (B), preferably 10% by mass or more, and more preferably 20% by mass or more with respect to the whole amount of liquid (A) (100% by mass). Further, an upper limit of a content of a first organic solvent is, from the viewpoint of dispersibility, preferably 94% by mass or less, and more preferably 90% by mass or less with respect to the whole amount of liquid (A) (100% by mass).

[Liquid (B) Containing Alkoxysilane or its Condensate and Second Organic Solvent]

Liquid (B) is common in the first and third embodiments of the present invention, and the following description is also common to them.

Liquid (B) containing an alkoxysilane or its condensate and a second organic solvent of the present invention can be prepared by mixing an alkoxysilane or its condensate with a second organic solvent. Since excessively high concentration of an alkoxysilane or its condensate tends to result in severe reaction, which readily leads to production of gel-like material, and from the viewpoint of miscibility, liquid (B) is preferably prepared by dissolving an alkoxysilane or its condensate in an organic solvent.

In addition to an alkoxysilane or its condensate and a second organic solvent, liquid (B) can contain other constituents so long as they do not impair the effect of the present invention.

Examples of an alkoxysilane or its condensate contained in liquid (B) include tetramethoxysilane, tetraethoxysilane, tetrapropoxysilane, or their condensate. The alkoxysilane or its condensate may be used solely, or two or more alkoxysilanes or their condensates may be used in combination. Among the alkoxysilanes or their condensates, from the viewpoint of having a suitable hydrolytic reactivity, tetramethoxysilane is preferred.

As a second organic solvent contained in liquid (B), a hydrophilic organic solvent is preferably used. Specific examples of the second organic solvent include alcohols such as methanol, ethanol, n-propanol, isopropanol, ethylene glycol, propylene glycol, 1,4-butanediol; and ketones such as acetone and methyl ethyl ketone, or the like.

Especially in the present invention, as the second organic solvent, alcohols are preferred. By using alcohols, when water substitution (described below) of the silica sol is carried out, alcohols can be easily substituted with water by heat distillation. Further, from the viewpoint of recovery and reuse of organic solvents, it is preferable to use alcohols of the same types as an alcohol produced by hydrolysis of an alkoxysilane. Among the alcohols, methanol, ethanol, isopropanol, or the like is more preferred. For example, when tetramethoxysilane is used as an alkoxysilane, a second organic solvent is preferably methanol. The second organic solvent may be used solely, or two or more of the second organic solvents may be used in combination. Further, from the viewpoint of recovery and reuse of organic solvents, it is preferred that a second organic solvent contained in liquid (B) is the same as the first organic solvent contained in liquid (A). Therefore, in a more preferred mode, the first organic solvent and the second organic solvent are methanol.

Contents of an alkoxysilane or its condensate and a second organic solvent in liquid (B) is not specifically limited, and can be suitably adjusted according to a desired shape, particle size, or the like. An upper limit of a content of an alkoxysilane or its condensate is adjusted according to an amount of an alkoxysilane or its condensate used for reaction, and the upper limit is, from the viewpoint of hydrolysis of an alkoxysilane, preferably 98% by mass or less, and more preferably 95% by mass or less with respect to the whole amount of liquid (B) (100% by mass). Further, a lower limit of a content of an alkoxysilane or its condensate is preferably 50% by mass or more, and more preferably 60% by mass or more with respect to the whole amount of liquid (B) (100% by mass). A lower limit of a content of a second organic solvent is preferably 2% by mass or more, and more preferably 5% by mass or more with respect to the whole amount of liquid (B) (100% by mass). Further, an upper limit of a content of a second organic solvent is preferably 50% by mass or less, and more preferably 40% by mass or less with respect to the whole amount of liquid (B) (100% by mass).

For example, when tetramethoxysilane is used as an alkoxysilane and methanol is used as a second organic solvent, an upper limit of a content of tetramethoxysilane is preferably 98% by mass or less, and more preferably 95% by mass or less with respect to the whole amount of liquid (B) (100% by mass). Further, a lower limit of a content of tetramethoxysilane is preferably 50% by mass or more, and more preferably 60% by mass or more with respect to the whole amount of liquid (B) (100% by mass). When a content of an alkoxysilane is 50% by mass or more and 98% by mass or less, high miscibility is achieved when mixed with liquid (A), and a gel-like material is hard to be produced, and thus a high-concentration silica sol can be made. When methanol is used as a second organic solvent, a lower limit of a content of methanol is preferably 2% by mass or more, and more preferably 5% by mass or more with respect to the whole amount of liquid (B) (100% by mass). Further, an upper limit of a content of methanol as a second organic solvent is, from the viewpoint of dispersibility, preferably 50% by mass or less, and more preferably 40% by mass or less with respect to the whole amount of liquid (B) (100% by mass).

[Liquid (C) Containing Water]

Liquid (C) containing water in a first embodiment of the present invention contains water. In addition to water and an organic acid to be added if necessary, liquid (C) can contain other constituents so long as they do not impair the effect of the present invention.

[Liquid (C1) Having pH of 5.0 or More and Less than 8.0 and Containing Water]

Liquid (C1) having a pH of 5.0 or more and less than 8.0 and containing water in a second embodiment of the present invention contains water. In addition to water and an organic acid to be added if necessary, liquid (C1) can contain other constituents so long as they do not impair the effect of the present invention and resultant liquid (C1) has a pH of 5.0 or more and less than 8.0.

A pH of liquid (C1) is 5.0 or more and less than 8.0. When the pH of liquid (C1) is less than 8.0, local increase in concentration of a hydroxide ion in a reaction liquid can be suppressed, and thus steady reaction is made possible. Further, when the pH is 5.0 or more, gelation of a reaction liquid can be suppressed. A pH of liquid (C1) is, from the viewpoint of suppressing gelation of a reaction liquid, preferably 5.5 or more, and more preferably 6.0 or more. A pH of liquid (C1) measured corresponds to a value obtained by a method used for measurement in Examples.

Water contained in liquid (C1) is, from the viewpoint of reducing contamination of a metallic impurity or the like, preferably pure water or ultrapure water.

In a second embodiment of the present invention, liquid (C1) may contain or may be free of an alkaline catalyst. However, liquid (C1) is, from the viewpoint that it is possible to make the obtained silica particle uniform in size and to highly concentrate silica particles, preferably free of an alkaline catalyst.

[Liquid (C2) Containing Water and being Free of Alkaline Catalyst]

Liquid (C2) in a third embodiment of the present invention contains water and is free of an alkaline catalyst. Since liquid (C2) is free of an alkaline catalyst, local increase in concentration of an alkaline catalyst in a reaction liquid can be suppressed, and thus a silica particle having a uniform particle size can be obtained.

Water contained in liquid (C2) is, from the viewpoint of reducing contamination of a metallic impurity or the like, preferably pure water or ultrapure water.

[First Step of Adding Organic Acid]

A production method of the present invention includes a first step of adding an organic acid to at least one of liquid (A) containing an alkaline catalyst, water, and a first organic solvent and liquid (C) containing water. In the first step, an organic acid is preferably added to liquid (A) containing an alkaline catalyst, water, and a first organic solvent. Liquid (C) in the first step is preferably liquid (C1) or liquid (C2).

Specific examples of the organic acid to be added in the first step include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofuran carboxylic acid, methoxyacetic acid, methoxyphenylacetic acid, and phenoxyacetic acid. Organic sulfuric acids such as methanesulfonic acid, ethanesulfonic acid, and isethionic acid may be used. Among the organic acids, from the viewpoint of high versatility, dicarboxylic acids such as malonic acid, succinic acid, glutaric acid, adipic acid, pimelic acid, maleic acid, phthalic acid, malic acid, and tartaric acid, and tricarboxylic acid such as citric acid and methanesulfonic acid are preferred. At least one selected from the group consisting of maleic acid and methanesulfonic acid is more preferred.

An amount of an organic acid to be added is, from the viewpoint of having no effect on the particle shape, preferably 0.003% by mass or more, and more preferably 0.006% by mass or more with respect to the whole amount of a liquid (100% by mass) which is resulted from mixing the whole amounts of liquid (A), liquid (B), and liquid (C), even when being added to either liquid (A) or liquid (C). An upper limit of the amount of the organic acid to be added is, from the viewpoint that aggregates are generated during synthesis, preferably 0.600% by mass or less, more preferably 0.300% by mass or less, and still more preferably 0.150% by mass or less with respect to the whole amount of a liquid (100% by mass) which is resulted from mixing the whole amounts of liquid (A), liquid (B), and liquid (C).

[Second Step of Making Reaction Liquid]

A production method of the present invention includes a second step of mixing liquid (A) with liquid (B) and liquid (Cx) (liquid (Cx) refers to a comprehensive concept including at least one selected from the group consisting of liquid (C), liquid (C1), and liquid (C2) in the present specification) to make a reaction liquid. In the resultant reaction liquid, an alkoxysilane or its condensate is hydrolyzed and polycondensed to produce a silica sol. Thus, the silica sol may be used as it is according to applications, or as a liquid obtained after the following water substitution step or concentration step, or as an organosol dispersed in an organic solvent.

According to a method for producing a silica sol of the present invention, a silica sol having a uniform particle size of silica particles can be steadily obtained.

A method of adding liquid (B) and liquid (Cx) in mixing of liquid (A) with liquid (B) and liquid (Cx) is not specifically limited. Almost constant amount of each of liquid (B) and liquid (Cx) may be added to liquid (A) simultaneously, or liquid (B) and liquid (Cx) may be added to liquid (A) alternately. On the other hand, liquid (B) and liquid (Cx) may be added at random. Among the above-described methods, from the viewpoint of reducing change in amount of water used for a synthesis reaction in a reaction liquid, a method of simultaneously adding liquid (B) and liquid (Cx) is preferably used, and a method of simultaneously adding almost constant amount of each of liquid (B) and liquid (Cx) is more preferably used.

Further, in a method of adding liquid (B) and liquid (Cx) to liquid (A), from the viewpoint that local increase in concentration of an alkaline catalyst in a reaction liquid can be suppressed, dividing addition or continuous addition of liquid (B) and liquid (Cx) to liquid (A) is preferred.

Dividing addition does not refer to simultaneously adding the whole amount of liquid (B) and liquid (Cx) when liquid (B) and liquid (Cx) are added to liquid (A), but refers to non-continuously or continuously adding liquid (B) and liquid (Cx) divided to 2 or more portions. Specific examples of dividing addition include dropping.

Continuous addition does not refer to simultaneously adding the whole amount of liquid (B) and liquid (Cx) when liquid (B) and liquid (Cx) are added to liquid (A), but refers to continuously adding them without interruption of the addition.

Although it varies according to a liquid measure of liquid (B) or liquid (Cx), time required for the addition of the whole amount of liquid (B) and liquid (Cx) to liquid (A) may be, for example, 10 minutes or more, and the time can be suitably adjusted according to a desired particle size. Time required for the addition of the whole amount of liquid (B) and liquid (Cx) to liquid (A) is, from the viewpoint that local increase in concentration of an alkaline catalyst in a reaction liquid is suppressed, preferably 15 minutes or more, and more preferably 20 minutes or more. When liquid (B) and liquid (Cx) are added to liquid (A), it is not preferred that the whole amount of liquid (B) and liquid (Cx) is added to liquid (A) within a short time, that is, without spending time longer than a certain period of time, or that the whole amount of liquid (B) and liquid (Cx) is added to liquid (A) at a time, from the viewpoint that unevenness of concentration of each constituent in a reaction liquid occurs. Further, an upper limit of time required for the addition of the whole amount of liquid (B) and liquid (Cx) to liquid (A) is not specifically limited, and the upper limit can be suitably adjusted in consideration of productivity and according to a desired particle size.

When liquid (A) is mixed with liquid (B) and liquid (Cx), a preferable method of adding liquid (B) and liquid (Cx) is, from the viewpoint of making particle size of a silica particle uniform, a method in which the liquid (B) and the liquid (Cx) are each added simultaneously in almost constant amount for a fixed time or more and the addition is completed simultaneously.

Temperatures of liquid (A), liquid (B), and liquid (Cx) in making a reaction liquid are not specifically limited. Here, the temperatures of liquid (A), liquid (B), and liquid (Cx) in making the reaction liquid refer to a temperature of each of the liquids when liquid (B) and liquid (Cx) are added to liquid (A). By regulating a temperature of the reaction liquid (each of the liquids), a particle size of a silica particle can be regulated.

A lower limit of each of the liquid temperatures is preferably 0° C. or more, and more preferably 10° C. or more. An upper limit of each of the liquid temperatures may be the same or different, and are preferably 70° C. or less, more preferably 60° C. or less, and still more preferably 50° C. or less. That is, it is preferable that temperatures of liquid (A), liquid (B), and liquid (Cx) be each independently 0 to 70° C. When the temperature is 0° C. or more, freezing of an alkoxysilane can be prevented. On the other hand, when the temperature is 70° C. or less, volatilization of an organic solvent can be prevented.

As described above, temperatures of liquid (A), liquid (B), and liquid (Cx) may be the same or different, and a difference among temperatures of liquid (A), liquid (B), and liquid (Cx) are, from the viewpoint of making particle size of a silica particle uniform, preferably within 20° C. Here, a difference among temperatures refers to a difference between the highest temperature and the lowest temperature of the three liquids.

In a method for producing a silica sol in an embodiment of the present invention, the hydrolysis and polycondensation reactions can be carried out under any pressure condition of reduced pressure, atmospheric pressure, or elevated pressure. However, from the viewpoint of production costs, the reactions are preferably carried out under atmospheric pressure.

A molar ratio of an alkoxysilane or its condensate, water, an alkaline catalyst, and a first organic solvent and a second organic solvent in the reaction liquid is not specifically limited, and the molar ratio can be adjusted according to a content of an alkaline catalyst contained in liquid (A) or a content of an alkoxysilane or its condensate contained in liquid (B).

In the present specification, “a reaction liquid” refers to a mixed liquid of liquid (A) with liquid (B) and liquid (Cx), and refers to a liquid under conditions in which hydrolysis and polycondensation of an alkoxysilane or its condensate are proceeding (before proceeding). On the other hand, “a silica sol” refers to a liquid after completion of the hydrolysis and polycondensation.

That is, the molar ratio is a molar ratio of the total of liquid (A), liquid (B), and liquid (Cx) used in the reaction, in other words, a molar ratio of an alkoxysilane or its condensate, water, an alkaline catalyst, and an organic solvent (the total amounts of first and second organic solvents) contained in the whole amounts of a reaction liquid (liquid (A)+liquid (B)+liquid (Cx)) which is resulted from addition of liquid (B) and liquid (Cx) to liquid (A). Briefly, the molar ratio refers to a molar ratio in the whole amounts of a reaction liquid (liquid (A)+liquid (B)+liquid (Cx)) which is resulted from addition of liquid (B) and liquid (Cx) to liquid (A).

A molar ratio of water contained in the reaction liquid is, when a mole number of an alkoxysilane is defined as 1.0, preferably 2.0 to 12.0 moles, and more preferably 3.0 to 6.0 moles. When a molar ratio of water is 2.0 moles or more, an amount of unreacted material can be reduced. When a molar ratio of water is 12.0 moles or less, concentration of silica particles of an obtained silica sol can be increased. Then, when a condensate of N-mer (N represents an integer of 2 or more) of an alkoxysilane is used, a molar ratio of water in a reaction liquid is N times as much as that resulted from using an alkoxysilane. That is, when a condensate of dimer of an alkoxysilane is used, a molar ratio of water in a reaction liquid is twice as much as that resulted from using an alkoxysilane.

A molar ratio of an alkaline catalyst contained in the reaction liquid is, when a mole number of an alkoxysilane or its condensate is defined as 1.0, preferably 0.1 to 1.0 moles. When a molar ratio of an alkaline catalyst is 0.1 or more, an amount of unreacted material can be reduced. When a molar ratio of an alkaline catalyst is 1.0 or less, steadiness of reaction can be improved.

A molar ratio of the total amounts of first and second organic solvents contained in the reaction liquid is, when a mole number of an alkoxysilane or its condensate is defined as 1.0, preferably 2.0 to 20.0 moles, and more preferably 4.0 to 17.0 moles. When a molar ratio of the organic solvent is 2.0 moles or more, an amount of unreacted material can be reduced, and when the molar ratio is 20.0 moles or less, concentration of silica particles of an obtained silica sol can be increased.

That is, it is preferred that a molar ratio of an alkoxysilane, water, an alkaline catalyst, and first and second organic solvents in a reaction liquid is (alkoxysilane):(water):(alkaline catalyst):(organic solvents)=(1.0):(2.0 to 12.0):(0.1 to 1.0):(2.0 to 20.0). Further, a molar ratio of a condensate of an alkoxysilane, water, an alkaline catalyst, and first and second organic solvents in a reaction liquid is, when a condensate of an alkoxysilane is made as N-mer (N represents an integer of 2 or more), preferably (condensate of alkoxysilane):(water):(alkaline catalyst):(organic solvents)=(1.0):(2.0×N to 12.0×N):(0.1 to 1.0):(2.0 to 20.0).

Shape of a silica particle in a silica sol is preferably non-spherical. Specifically, an average circularity of silica particles in the silica sol is preferably 0.60 or less. In the present specification, the average circularity indicates a value obtained by calculating an average circularity of silica particles contained in the silica sol. In the present specification, the average circularity indicates a value calculated by a method described in Examples below. The closer the circularity is to 1, the more spherical the particle is. Therefore, the closer the average circularity is to 1, the more the proportion of particles having a nearly spherical shape contained in the silica sol is. A production method of the present invention can consistently produce a silica sol in which an average circularity of silica particles calculated based on an image observed with a scanning electron microscope is 0.60 or less. In other words, the present invention can produce a silica sol containing a large amount of non-spherical silica particles having a lower circularity. Therefore, by using the silica sol obtained by the production method of the present invention as abrasive grains in a polishing composition, it is possible to further improve polishing performance such as reduction in dishing and improvement in polishing speed.

An average aspect ratio of silica particles in a silica sol is preferably 1.00 or more, more preferably 1.05 or more, still more preferably 1.1 or more, and most preferably 1.2 or more. In the present specification, the average aspect ratio indicates a value obtained by calculating an average aspect ratio of silica particles contained in the silica sol. In the present specification, the average aspect ratio indicates a value calculated by a method described in Examples below. The closer the aspect ratio is to 1, the more non-flat the particle is. Therefore, the closer the average aspect ratio is to 1, the more the proportion of particles having a nearly non-flat shape contained in the silica sol is.

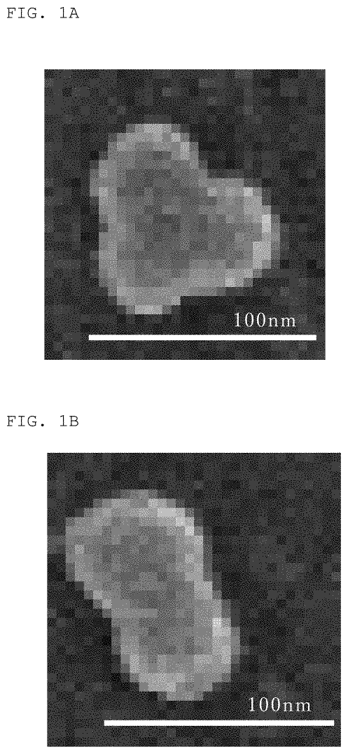

An average circularity of a silica sol obtained by a production method of the present invention is low even when an average aspect ratio of silica particles is 1 or close to 1. Therefore, the reason why high polishing performance can be exhibited will be described based on FIGS. 1A and 1B. FIG. 1A shows a triangular and irregular-shaped silica particle in which three particles are bound (hereinafter referred to as “triangular irregular-shaped silica particle”), and FIG. 1B shows an elliptical and irregular-shaped silica particle in which two particles are bound (hereinafter referred to as “elliptical irregular-shaped silica particle”). Both the triangular irregular-shaped silica particle and the elliptical irregular-shaped silica particle have a particle size of about 78 nm, but an aspect ratio of the triangular irregular-shaped silica particle is 1.00 and an aspect ratio of the elliptical irregular-shaped silica particle is 1.54. However, the triangular irregular-shaped silica particle showing a higher degree of association than the elliptical irregular-shaped silica particle have a shape that reduces dishing and improves polishing performance such as a high polishing speed. From this, it is considered that the shape of the silica particles for improving the polishing performance cannot be determined by the aspect ratio alone. In the present invention, focusing on the circularity of the silica particles, it has been found that a silica sol containing silica particles having a low circularity which can improve the polishing performance can be obtained by devising the timing of adding an organic acid, and thus a novel method for producing a silica sol has been completed.

A particle size of a silica particle in a silica sol is not specifically limited, and a lower limit of an average primary particle size of silica particles is preferably 5 nm or more, more preferably 7 nm or more, and still more preferably 10 nm or more. Further, an upper limit of an average primary particle size of silica particles in a polishing composition of the present invention is preferably 120 nm or less, more preferably 80 nm or less, and still more preferably 50 nm or less. Within such a range, it is possible to reduce defects such as scratches that may occur on a surface of an object to be polished after polishing with the polishing composition. Note that, an average primary particle size of an abrasive grain is calculated, for example, based on a specific surface area of the abrasive grain measured by BET method.

As an average secondary particle size of silica particles in a silica sol obtained by a production method of the present invention, a desired particle size can be selected, and the average secondary particle size of silica particles is preferably 5.0 to 1000.0 nm. A lower limit of an average secondary particle size of silica particles is preferably 10 nm or more, more preferably 15 nm or more, still more preferably 20 nm or more, particularly preferably 50 nm or more, and most preferably 55 nm or more. Further, in the polishing composition of the present invention, an upper limit of an average secondary particle size of silica particles is preferably 350 nm or less, more preferably 250 nm or less, still more preferably 200 nm or less, particularly preferably 150 nm or less, and most preferably 100 nm or less. Within such a range, it is possible to reduce defects such as scratches that may occur on a surface of an object to be polished after polishing with the polishing composition. Note that, a value of an average secondary particle size of silica particles can be measured as a volume average particle size by, for example, dynamic light scattering method. Specifically, an assumption is made that particle sizes of silica particles are measured by dynamic light scattering method, and then the number of particles having particle sizes of d1, d2, . . . di, . . . dk is n1, n2, . . . ni . . . nk, respectively. Further, an assumption is made that volume of each one of particles is vi. In this case, the volume average particle size is calculated by Σ (vidi)/Σ (vi), which is an average diameter weighted by volume.

A concentration of silica particles in a silica sol manufactured by a production method of the present invention varies according to a particle size of an obtained silica particle, and for example, when an average secondary particle size is 50 to 350 nm, the concentration is preferably 5% by mass or more and 30% by mass or less, and more preferably 7% by mass or more and 25% by mass or less.

A pH of a silica sol manufactured by a production method of the present invention is preferably 7.0 to 13.0, and more preferably 8.0 to 12.0.

According to a production method of the present invention, a total content of metallic impurities contained in the silica sol such as Al, Ca, B, Ba, Co, Cr, Cu, Fe, Mg, Mn, Na, Ni, Pb, Sr, Ti, Zn, Zr, U, Th, or the like can be 1 ppm or less.

<Post-Processing Step>

In a method for producing a silica sol of the present invention, in addition to the above-described step of making a reaction liquid, a post-processing step described below may be carried out.

Specifically, at least one of a water substitution step of substituting an organic solvent present in the silica sol with water and a concentration step of concentrating the silica sol may be carried out. More specifically, a concentration step of concentrating the silica sol may be carried out solely; a water substitution step of substituting an organic solvent in the silica sol with water may be carried out solely; after the concentration step, a water substitution step of substituting an organic solvent in the concentrated liquid with water may be carried out; or, after the water substitution step is carried out, a concentration step of concentrating the water-substituted liquid may be carried out. Further, multiple concentration steps may be carried out, where a water substitution step may be carried out between a concentration step and another concentration step; for example, after a concentration step, a water substitution step of substituting an organic solvent in a concentrated liquid with water is carried out, and then another concentration step of concentrating the water-substituted liquid may be further carried out.

[Water Substitution Step]

A method for producing a silica sol of the present invention may include, as one embodiment of the present invention, a step of substituting an organic solvent contained in the silica sol with water (also simply referred to as “a water substitution step” in the present specification). A silica sol of this mode also includes a configuration in which a silica sol is subjected to a concentration step (a concentrated silica sol).

When ammonia is selected as an alkaline catalyst, by substituting an organic solvent in the silica sol with water, a pH of the silica sol can be adjusted to a neutral region, and a water-substituted silica sol stable for a long period can be obtained by removing unreacted materials contained in the silica sol.

As a method of substituting an organic solvent in the silica sol with water, a conventionally known method can be used, and examples of the method include a method of substitution by using heat distillation with dropping water while keeping a liquid measure of the silica sol at a constant amount or more. In this case, the substitution operation is preferably continued until liquid temperature and overhead temperature reach a boiling point of water for substitution.

As water used in this step, from the viewpoint of reducing contamination of a metallic impurity or the like, pure water or ultrapure water is preferably used.

Further, a method of substituting an organic solvent in the silica sol with water also includes a method of separating a silica particle by centrifugal separation followed by redispersing the resultant in water.

[Concentration Step]

A method for producing a silica sol of the present invention may further include, as one embodiment of the present invention, a step of concentrating the silica sol (also simply referred to as “a concentration step” in the present specification). Note that, a silica sol of this mode also includes a configuration in which a silica sol is subjected to a water substitution step (a water-substituted silica sol).

A method of concentrating a silica sol is not specifically limited, and a conventionally known method can be used, and examples of the method include a heat concentration method, a membrane concentration method, or the like.

In a heat concentration method, a silica sol is heated and concentrated under atmospheric pressure or under reduced pressure to obtain a concentrated silica sol.

In a membrane concentration method, a silica sol can, for example, be concentrated through membrane separation by ultrafiltration in which a silica particle can be filtered. A molecular weight cut-off of an ultrafiltration membrane is not specifically limited, and can be selected according to a particle size of produced particles. A material constituting an ultrafiltration membrane is not specifically limited, and examples of the material include polysulfone, polyacrylonitrile, a sintered metal, a ceramic, carbon, or the like. A configuration of an ultrafiltration membrane is not specifically limited, and examples of the configuration include spiral type, tubular type, hollow fiber type, or the like. In an ultrafiltration, operation pressure is not specifically limited, and can be set at a pressure not exceeding a working pressure of an ultrafiltration membrane used.

It is clear that the embodiments of the present invention described in detail are descriptive and illustrative, and not restrictive, and the scope of the present invention should be construed by the appended claims.

The present invention includes the following aspects and modes:

1. A method for producing a silica sol including:

a first step of adding an organic acid to at least one of liquid (A) containing an alkaline catalyst, water, and a first organic solvent and liquid (C) containing water; and

a second step of mixing the liquid (A) with liquid (B) containing an alkoxysilane or its condensate and a second organic solvent, and the liquid (C) to make a reaction liquid after the first step.

2. The method for producing a silica sol according to the above 1., in which the liquid (C) is liquid (C1) containing water and having a pH of 5.0 or more and less than 8.0.

3. The method for producing a silica sol according to the above 2., in which the liquid (C1) is free of an alkaline catalyst.

4. The method for producing a silica sol according to the above 1., in which the liquid (C) is liquid (C2) containing water and being free of an alkaline catalyst.

5. The method for producing a silica sol according to any one of the above 1. to 3., in which, in the second step, temperatures of the liquid (A), the liquid (B), and the liquid (C) or the liquid (C1) are each independently 0 to 70° C.

6. The method for producing a silica sol according to the above 1. or 4., in which, in the second step, temperatures of the liquid (A), the liquid (B), and the liquid (C) or the liquid (C2) are each independently 0 to 70° C.

7. The method for producing a silica sol according to any one of the above 1. to 6., in which the alkoxysilane is tetramethoxysilane.

8. The method for producing a silica sol according to any one of the above 1. to 7., in which the alkaline catalyst contained in the liquid (A) is at least one of ammonia and an ammonium salt.

9. The method for producing a silica sol according to the above 8., in which the alkaline catalyst contained in the liquid (A) is ammonia.

10. The method for producing a silica sol according to any one of the above 1. to 9., in which the first organic solvent and the second organic solvent are methanol.

11. The method for producing a silica sol according to any one of the above 1. to 10., in which the organic acid is at least one selected from the group consisting of maleic acid and methanesulfonic acid.

12. The method for producing a silica sol according to any one of the above 1. to 11., in which an average circularity of silica particles calculated based on an image observed with a scanning electron microscope is 0.60 or less.

### EXAMPLES

The present invention is described in more detail with reference to the following Examples and Comparative Examples. However, the technical scope of the present invention is not limited to the following Examples. Note that, unless otherwise indicated, “%” and “parts” refer to “% by mass” and “parts by mass”, respectively. Further, in the following Examples, unless otherwise indicated, operations were carried out under conditions of at room temperature (20 to 25° C.) and relative humidity of 40 to 50% RH.

### Example 1

(Preparation Step of Silica Sol; First Step and Second Step)

Liquid (A) where 121 g of pure water and 73 g of 29 wt % aqueous ammonia solution were mixed with 1222 g of methanol was mixed with 0.28 g of maleic acid. Then, into this liquid (A), liquid (B) in which 507 g of tetramethoxysilane (TMOS) was dissolved in 190 g of methanol and liquid (C) which was 120 g of pure water were dropped for 60 minutes while holding a temperature of each liquid at 35° C. to make a reaction liquid, and thus a silica sol was obtained.

A molar ratio of TMOS, pure water, ammonia, and methanol in the reaction liquid was TMOS:pure water:ammonia:methanol=1.0:4.0:0.37:13 (however, when water derived from an aqueous ammonia solution was included, TMOS:water:ammonia:methanol=1.0:4.9:0.37:13).

(Concentration Step of Silica Sol)

2233 g of the silica sol obtained in the above-described preparation step of a silica sol was added to a heating container, the heating container was heated under atmospheric pressure with a mantle heater stirrer (model: MS-ES10), and the silica sol was concentrated to obtain a concentrated silica sol.

(Water Substitution Step of Silica Sol)

A water substitution step of a silica sol was performed by heating and distilling the silica sol obtained in the concentration step of a silica sol. When the silica sol was heated and distilled, the liquid measure of the silica sol was maintained at a constant amount or more by adding water, and methanol in the silica sol was substituted with water to obtain a silica sol of Example 1.

### Example 2

Operations were carried out similarly to those of Example 1 to make a reaction liquid except that 0.28 g of maleic acid to be added to liquid (A) was replaced with 0.28 g of methanesulfonic acid, and thus a silica sol was obtained. Then, a silica sol of Example 2 was obtained by the concentration step of a silica sol and the water substitution step of a silica sol similar to those of Example 1.

### Comparative Example 1

Operations were carried out similarly to those of Example 1 to make a reaction liquid except that 0.28 g of maleic acid was not added to liquid (A), and thus a silica sol was obtained. Then, a silica sol of Comparative Example 1 was obtained by performing the concentration step of a silica sol and the water substitution step of a silica sol similar to those of Example 1.

### Comparative Example 2

Operations were carried out similarly to those of Example 1 to make a reaction liquid except that 0.28 g of maleic acid was not added to liquid (A) and liquid (B) and liquid (C) were dropped for 15 minutes, and thus a silica sol of Comparative Example 2 was obtained. Note that, in Comparative Example 2, the concentration step of a silica sol and the water substitution step of a silica sol were not performed.

### Comparative Example 3

Operations were carried out similarly to those of Example 1 to make a reaction liquid except that 0.28 g of maleic acid was not added to liquid (A) and a temperature of each liquid was changed to 25° C. in preparing a reaction liquid, and thus a silica sol of Comparative Example 3 was obtained. Note that, in Comparative Example 3, the concentration step of a silica sol and the water substitution step of a silica sol were not performed.

### Comparative Example 4

Operations were carried out similarly to those of Example 1 to make a reaction liquid except that 0.28 g of maleic acid was not added to liquid (A). Then, 0.28 g of maleic acid was added to the obtained silica sol. Then, a silica sol of Comparative Example 4 was obtained by performing the concentration step of a silica sol and the water substitution step of a silica sol similar to those of Example 1.

Raw materials and reaction conditions of Examples 1 and 2 and Comparative Examples 1 to 4 are shown in Table 1. Note that, in Table 1, each reaction temperature is a value obtained by using Lacom tester pH & conductivity meter PCWP300 (manufactured by Eutech Instruments Pte Ltd.), immersing the electrode of this meter in a reaction liquid, and measuring a temperature of the reaction liquid from the start of addition (at the start of synthesis). This reaction temperature indicates a temperature of liquid (A). Note that, since liquid (B) and liquid (C) are added to liquid (A) at room temperature (20 to 25° C.), a temperature of each liquid of liquid (B) and liquid (C) is room temperature (20 to 25° C.)

[Measurement of Physical Property Values]

With respect to silica particles in the silica sols prepared in Examples and Comparative Examples, the following physical property values were measured.

(Average Secondary Particle Size)

An average secondary particle size was measured as a volume average particle size by a dynamic light scattering method using a particle size distribution measurement apparatus (UPA-UT151, manufactured by Nikkiso Co., Ltd.).

(Image Observation)

An image of a silica sol was observed with a scanning electron microscope SU8000 (manufactured by Hitachi High-Tech Corporation) according to the following procedure.

The silica sol obtained as described above was dispersed in alcohol and dried. Thereafter, the dried silica sol was placed in a scanning electron microscope and irradiated with an electron beam at 5.0 kV. Several observation visual fields were photographed at a magnification of 50,000.

(Circularity and Aspect Ratio)

Captured SEM images were analyzed using image analysis type particle size distribution analysis software Mac-View Ver. 4 (manufactured by Mountech Co., Ltd.), and the circularity (average circularity) and the aspect ratio (average aspect ratio) were calculated by the following formulas.

Note that, the circularity and the aspect ratio are obtained by taking SEM images of 150 or more and less than 200 silica particles by SEM and analyzing the images. Therefore, an average circularity is obtained by determining an area of each particle (S) and a perimeter of each silica particle (L), calculating (each) circularity of each particle from the following formula, and averaging it. Further, an average aspect ratio is obtained by determining a minor axis and a major axis of a circumscribing rectangle having a minimum area in each particle, calculating (each) aspect ratio of each particle from the following formula, and averaging it. Note that, the silica particles used for calculating the average circularity and the average aspect ratio are all the particles of the captured SEM images. That is, each of the SEM images was adjusted so that the number of particles was 150 or more and less than 200, all the particles in the SEM image of the visual field were image-analyzed, and the average circularity and the average aspect ratio were calculated.

Circularity=4πS/L²(S=circular area,L=perimeter)

Aspect ratio=(minor axis of circumscribing rectangle with minimum area)/(major axis of circumscribing rectangle with minimum area)

(Silica Concentration)

Specifically, the silica concentration was determined as a value obtained by evaporating a silica sol to dryness, and carrying out a calculation using an amount of the resultant residue.

Note that, a silica concentration of silica sol which did not subjected to a concentration step or a water substitution step was determined by mixing liquid (A) with liquid (B) and liquid (C) to make a reaction liquid, and measuring a concentration of silica particles in the silica sol using the obtained silica sol.

Further, a silica concentration of silica sol after concentration and water substitution was determined by mixing liquid (A) with liquid (B) and liquid (C) to make a reaction liquid, subjecting the resultant silica sol to a concentration step and a water substitution step, and measuring a concentration of silica particles in the silica sol using the silica sol obtained after the steps.

(Viscosity)

Viscosity of a silica sol was measured by the following method. Canon-Fenske viscometers, manufactured by Sibata Scientific Technology, Ltd., No. 100 (viscometer constant: 0.015), No. 200 (viscometer constant: 0.1), and No. 300 (viscometer constant: 0.25) were sufficiently dried in an air bath at 100° C. After that, the temperatures of the viscometers were returned to room temperature. Note that, No. 75 was used for the silica sols of Examples 1 and 2 and Comparative Example 4, and No. 300 was used for the silica sol of Comparative Example 1.

Each of the Canon-Fenske viscometers, which had been returned to room temperature, was turned upside down, and the viscometer was filled with each of the silica sols. After preparing a 25° C. water bath, the viscometer was sufficiently immersed in the water bath so that the liquid temperature was the same. After that, in order to measure the outflow time, the upper and lower sides of the Canon-Fenske viscometer were returned to their original positions, and travel time between measurement reference lines indicated on the viscometer was measured with a stopwatch. Further, density of each of the silica sols was separately measured with a portable density/specific gravity/concentration meter, manufactured by Anton Paar Japan K.K. The viscosity was calculated from the obtained value using the following formula.

Kinematic viscosity (mm²/s)=viscometer constant×outflow time (seconds)

Viscosity (mPa·s)=kinematic viscosity (mm²/s)×density (g/cm³).

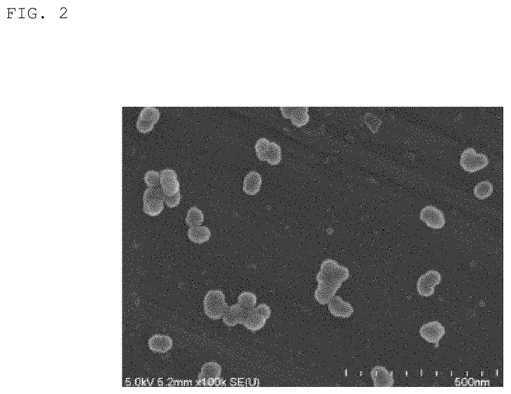

Results of the above-described measurement of physical property values are described in Table 2. In Table 2, “-” indicates that the value was not calculated. Further, FIG. 2 shows an image (at a magnification of 100,000) of the silica sol of Example 1 observed with a scanning electron microscope.

TABLE 1

| | liquid (A) after first step | | | | | | | | | | | |
|---|---|---|---|---|---|---|---|---|---|---|---|---|
| | liquid (A) | | | | | | | | | | | |
| | | | 29 wt % | | | | liquid (B) | | | | Reaction conditions | |
| | | | NH₃ | | | Whole | | | Whole | liquid | Reaction | Reaction |
| | Methanol | Water | Water | Organic acid | | amount | TMOS | Methanol | amount | (C) | temperature | time |
| | [g] | [g] | [g] | Kind | [g] | [g] | [g] | [g] | [g] | Water | [° C.] | (min.) |
| Example 1 | 1222 | 121 | 73 | Maleic acid | 0.28 | 1416 | 507 | 190 | 697 | 120 | 35 | 60 |
| Example 2 | 1222 | 121 | 73 | Methanesulfonic | 0.28 | 1416 | 507 | 190 | 697 | 120 | 35 | 60 |
| | | | | acid | | | | | | | | |
| Comparative | 1222 | 121 | 73 | No addition | 0 | 1416 | 507 | 190 | 697 | 120 | 35 | 60 |
| Example 1 | | | | | | | | | | | | |
| Comparative | 1222 | 121 | 73 | No addition | 0 | 1416 | 507 | 190 | 697 | 120 | 35 | 15 |
| Example 2 | | | | | | | | | | | | |
| Comparative | 1222 | 121 | 73 | No addition | 0 | 1416 | 507 | 190 | 697 | 120 | 25 | 60 |
| Example 3 | | | | | | | | | | | | |
| Comparative | 1222 | 121 | 73 | Maleic acid (Post | 0.28 | 1416 | 507 | 190 | 697 | 120 | 35 | 60 |
| Example 4 | | | | addition) | | | | | | | | |

TABLE 2

| | | | | | Silica | |
|---|---|---|---|---|---|---|
| | | | | | concentration | |
| | Average | | | | after | Viscosity after |
| | secondary | | | | concentration and | water |
| | particle size | Average | Average aspect | Silica | water substitution | substitution |
| | [nm] | circularity | ratio | concentration [%] | [%] | [mPa s] |
| Example 1 | 86 | 0.557 | 1.329 | 9 | 20 | 2 |
| Example 2 | 86 | 0.582 | 1.275 | 9 | 20 | 2 |
| Comparative | 52 | 0.610 | 1.235 | 9 | 20 | 128 |
| Example 1 | | | | | | |
| Comparative | 54 | 0.639 | 1.328 | 9 | — | — |
| Example 2 | | | | | | |
| Comparative | 84 | 0.675 | 1.256 | 9 | — | — |
| Example 3 | | | | | | |
| Comparative | 52 | 0.610 | 1.235 | 9 | 20 | 2 |
| Example 4 | | | | | | |

As shown in Table 2, the silica particles of Comparative Examples 1 to 3 had an average aspect ratio of 1.2 or more, but did not have an average circularity of 0.60 or less. In Comparative Example 4 in which the organic acid was added after the reaction liquid was made, the average circularity of the silica particles exceeded 0.60. This result suggests that the organic acid needs to be present during the preparation of the reaction liquid in order to obtain silica particles having a low circularity.

The silica particles obtained in Examples 1 and 2 had an average aspect ratio of 1.2 or more and an average circularity of 0.60 or less. Further, it can be seen from FIG. 2 that most of the silica particles contained in the silica sol of Example 1 are non-spherical.

In Examples 1 and 2, even if an organic acid was present in the reaction system at the time of producing the silica sols, there was no influence on the reaction time or the reaction temperature, and the silica sols could be preferably produced. It was also confirmed that the silica sols obtained in Examples 1 and 2 did not cause aggregation and the like, and that the organic acid did not influence the stability of the silica sols.

The present application is based on JP 2019-171827 filed on Sep. 20, 2019, the disclosure of which is incorporated herein by reference in its entirety.

1. A method for producing a silica sol comprising:
a first step of adding an organic acid to at least one of liquid (A) containing an alkaline catalyst, water, and a first organic solvent and liquid (C) containing water; and
a second step of mixing the liquid (A) with liquid (B) containing an alkoxysilane or its condensate and a second organic solvent, and the liquid (C) to make a reaction liquid after the first step.

2. The method for producing a silica sol according to claim 1, wherein the liquid (C) is liquid (C1) containing water and having a pH of 5.0 or more and less than 8.0.

3. The method for producing a silica sol according to claim 2, wherein the liquid (C1) is free of an alkaline catalyst.

4. The method for producing a silica sol according to claim 1, wherein the liquid (C) is liquid (C2) containing water and being free of an alkaline catalyst.

5. The method for producing a silica sol according to claim 1, wherein, in the second step, temperatures of the liquid (A), the liquid (B), and the liquid (C) or the liquid (C1) are each independently 0 to 70° C.

6. The method for producing a silica sol according to claim 1, wherein, in the second step, temperatures of the liquid (A), the liquid (B), and the liquid (C) or the liquid (C2) are each independently 0 to 70° C.

7. The method for producing a silica sol according to claim 1, wherein the alkoxysilane is tetramethoxysilane.

8. The method for producing a silica sol according to claim 1, wherein the alkaline catalyst contained in the liquid (A) is at least one of ammonia and an ammonium salt.

9. The method for producing a silica sol according to claim 8, wherein the alkaline catalyst contained in the liquid (A) is ammonia.

10. The method for producing a silica sol according to claim 1, wherein the first organic solvent and the second organic solvent are methanol.

11. The method for producing a silica sol according to claim 1, wherein the organic acid is at least one selected from the group consisting of maleic acid and methanesulfonic acid.

12. The method for producing a silica sol according to claim 1, wherein an average circularity of silica particles calculated based on an image observed with a scanning electron microscope is 0.60 or less.
